(19) United States
(12) Patent Application Publication
(10) Pub. No.: US 2021/0018358 A1
(43) Pub. Date: Jan. 21, 2021

(54) SCALE CALIBRATION DEVICE AND METHOD OF USE

(71) Applicant: Pelstar, LLC, McCook, IL (US)

(72) Inventors: Ken Harris, McCook, IL (US); Brian C. Skinner, McCook, IL (US)

(21) Appl. No.: 17/061,809

(22) Filed: Oct. 2, 2020

Related U.S. Application Data
(63) Continuation-in-part of application No. 16/145,276, filed on Sep. 28, 2018.
(60) Provisional application No. 62/564,861, filed on Sep. 28, 2017.

(51) Int. Cl. G01G 23/01; G01G 21/28

(52) U.S. Cl. CPC G01G 23/012; G01G 21/28

(57) ABSTRACT

A scale calibration device and method of use. The device may include a base supportable on and movable along a surface to a location. The base further includes a base surface for supporting a scale to be calibrated proximate the location. The device includes a frame assembly connected to the base and operable to support, in a position over the base surface, means for simulating a dead weight, the means being operable to apply a force to the scale supported on the base surface.

### RELATED APPLICATIONS

The present application claims priority to co-pending U.S. patent application Ser. No. 16/145,276, filed Sep. 28, 2018, which claims priority to U.S. Provisional Patent Application No. 62/564,861, filed Sep. 28, 2017, the entire contents of both of which are hereby incorporated by reference.

### FIELD

The present invention relates to calibration devices and methods of calibrating devices, such as scales and, more particularly, medical scales.

### SUMMARY

Scales to weigh people come in a variety of sizes. Typically, those used in the medical industry are larger and more robust than those for home use. It is important for scales, especially medical scales, to be accurately calibrated.

Current devices and methods for calibrating such scales are heavy and cumbersome, typically requiring standard weights weighing hundreds of pounds. Storage, movement and use of these calibration devices can be difficult and labor- and time-intensive.

In some independent embodiments, the present invention may provide a portable, force application device for the calibration, accuracy testing, etc., of a scale, such as a professional medical scale. The device may eliminate or minimize the need to transport and manipulate large certified test weights to accomplish such tasks. In some embodiments, the device may employ test software operating on a computing device, such as a tablet, laptop, personal computer, desktop, terminal, etc., to monitor an applied force, to log data, and/or to output such data (e.g., provide reports).

The device may be used to calibrate medical scales in lieu of certified test weights. For example, the National Institute of Standards and Technology (NIST) recommends that a 1000-pound (lb.) capacity scale be calibrated at a minimum weight of 300 pounds (lbs.). The device may improve calibration, accuracy testing, etc. of scales, compared to manipulating test weights. The device may be capable of single load point calibration as well as multiple load point calibration.

The device may also be capable of checking the accuracy of medical scales across their entire rated load range. For example, the force applied by the device can be compared to an indicated weight on the scale S to develop a scale performance curve. A review of this data can provide useful information on accuracy of the scale and/or help diagnose the nature of any inaccuracies of the scale.

The device may make scale testing practical, as the device can eliminate the prohibitive amount of effort and/or transportation of up to 1000 lbs. or more of certified test weights. These constraints have typically resulted in an industry practice that is tolerant of not reviewing scale performance across the entire operating load range of the scale.

In one independent aspect, a device may generally include a base supportable on and movable along a surface to a location, the base including a base surface for supporting a scale to be calibrated proximate the location; and a frame assembly connected to the base and operable to support, in a position over the base surface, means for simulating a dead weight, the means being operable to apply a force to the scale supported on the base surface.

In another independent aspect, a method of calibrating a scale may be provided. The method may generally include moving to a location a calibration device, the calibration device including a base with a base surface and a frame assembly connected to the base; supporting a scale to be calibrated proximate the location on the base surface; and, with a device supported on the frame assembly over the base surface, applying a force simulating a dead weight to the scale supported on the base surface to calibrate the scale.

In yet another independent aspect, a device may generally include a base supportable on and movable along a surface to a location, the base including a base surface for supporting a scale to be calibrated proximate the location; a frame assembly connected to the base; and means for simulating a dead weight supported on the frame assembly in a position over the base surface, the means for simulating a dead weight being operable to apply a force to the scale supported on the base surface to calibrate the scale.

In a further independent aspect, a scale calibration device may generally include a base supportable on and movable along a surface to a location, the base including a base surface for supporting a scale to be calibrated proximate the location; and a frame assembly connected to the base and operable to support a force-applying mechanism in a position over the base surface, the force-applying mechanism being operable to apply a force to the scale supported on the base surface.

In another independent aspect, a method of calibrating a scale may be provided. The method may generally include moving to a location a calibration device, the calibration device including a base with a base surface and a frame assembly connected to the base; supporting a scale to be calibrated proximate the location on the base surface; and applying a force to the scale supported on the base surface to calibrate the scale, applying including applying a force with a force-applying mechanism supported on the frame over the base surface.

In yet another independent aspect, a calibration device may generally include a base supportable on and movable along a surface to a location, the base including a base surface for supporting a scale to be calibrated proximate the location; a frame assembly connected to the base, the frame assembly having an end; and a force-applying mechanism supported on the end of the frame assembly in a position over the base surface, the force applying mechanism being operable to apply a force to the scale supported on the base surface to calibrate the scale.

Independent features and independent advantages of the invention may become apparent to those skilled in the art upon review of the following detailed description, claims and drawings.

### BRIEF DESCRIPTION OF THE DRAWINGS

FIG. 1 is a perspective view of a scale calibration device.

FIG. 2 is a front view of the device of FIG. 1.

FIG. 3 is a side view of the device of FIG. 1.

FIG. 4 is a top view of the device of FIG. 1.

FIG. 5 is a photo of a front perspective view a scale calibration device.

FIG. 6 is a photo of a perspective side view of the device of FIG. 5.

FIG. 7 is a photo of a perspective side view of the device of FIG. 5, illustrated supporting a scale to be calibrated.

FIG. 8 is a photo of a perspective view of an alternative scale calibration device.

FIG. 9 is a top perspective view of another alternative scale calibration device.

FIG. 10 is a bottom perspective view of the device of FIG. 9.

FIG. 11 is a front perspective view of the device of FIG. 9.

FIG. 12 is a top perspective view of yet another alternative scale calibration device.

FIG. 13 is a bottom perspective view of the device of FIG. 12.

FIG. 14 is a top perspective view of the device of FIG. 12, illustrated with the handle removed.

FIG. 15 is a top view of the device of FIG. 12.

FIG. 16 is a side view of the device of FIG. 12.

FIG. 17 is a rear view of the device of FIG. 12.

FIG. 18 is a cross-sectional view of the device of FIG. 12, taken generally along line 18-18 of FIG. 15.

FIG. 19 is a top perspective view of a span of the device of FIG. 12.

FIG. 20 is a top perspective view of a column of the device of FIG. 12.

FIG. 21 is a bottom perspective view of the base of the device of FIG. 12.

FIG. 22 is a cross-sectional view of the device of FIG. 12, taken generally along line 22-22 of FIG. 15.

FIG. 23 is an exploded view of the device of FIG. 12.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

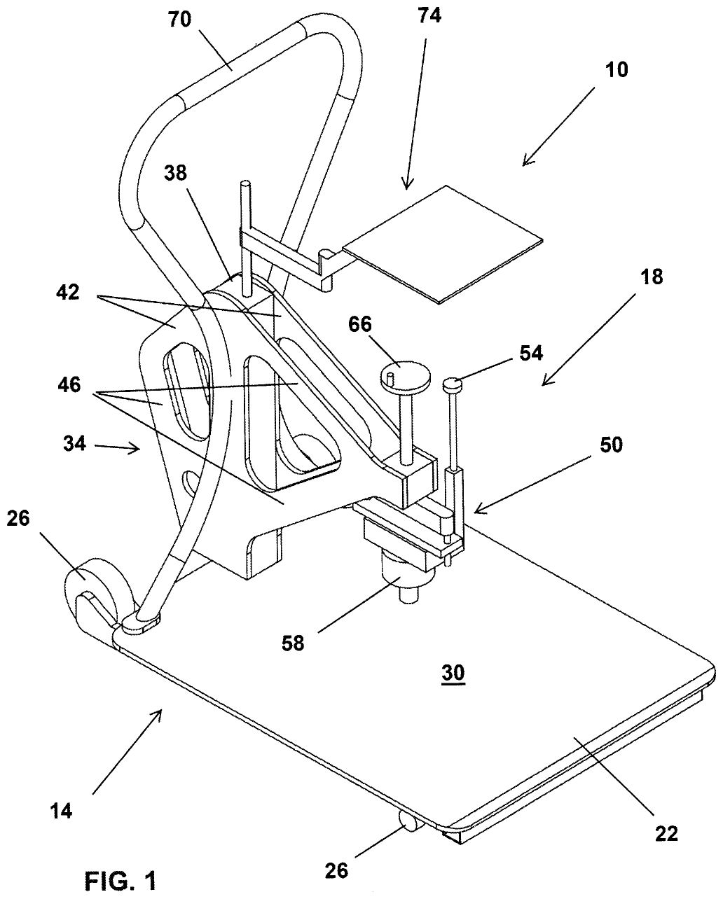

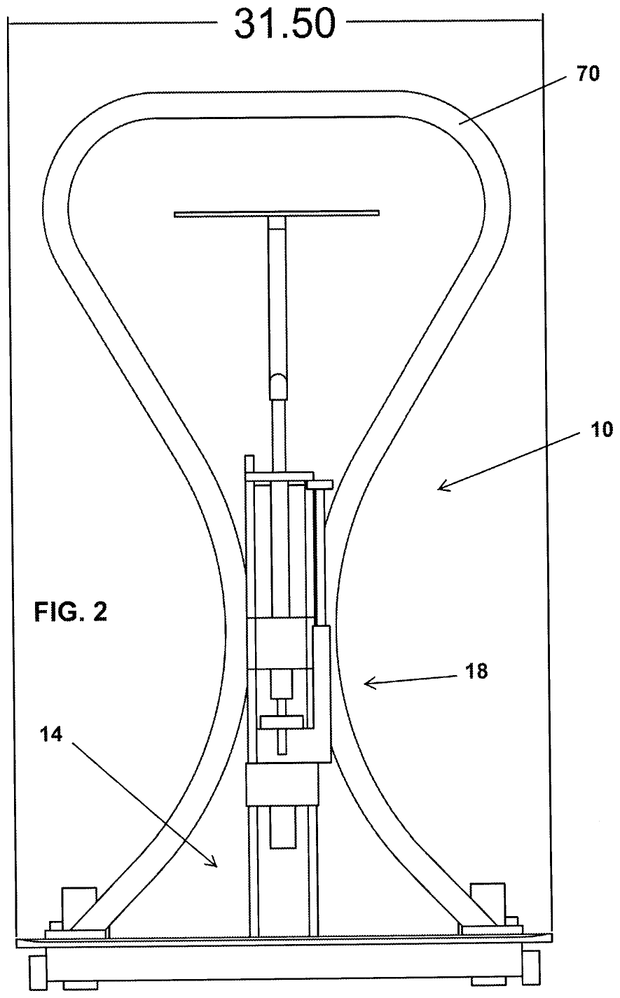

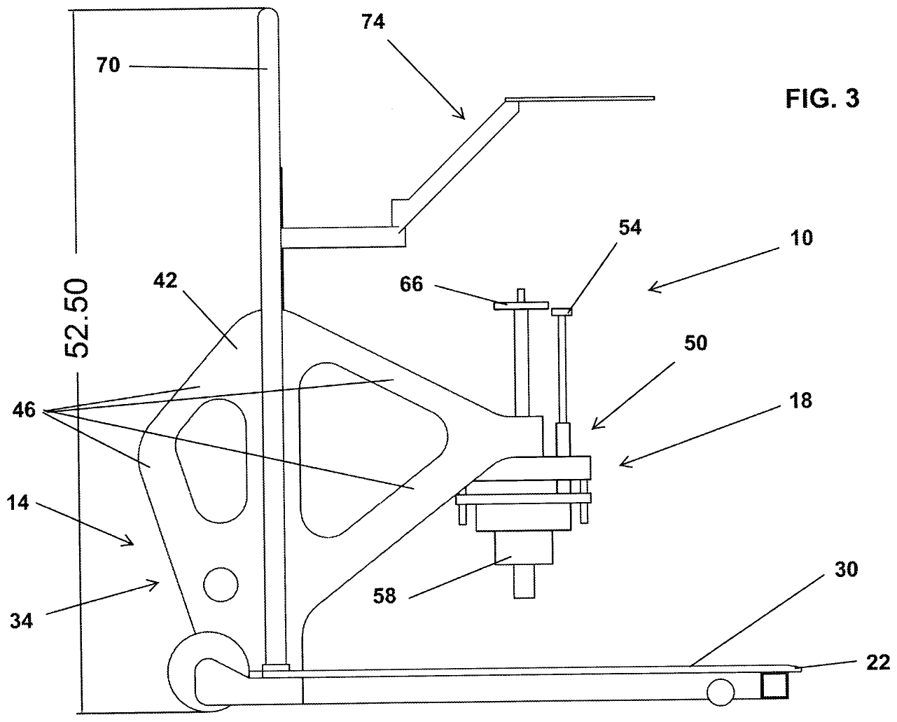

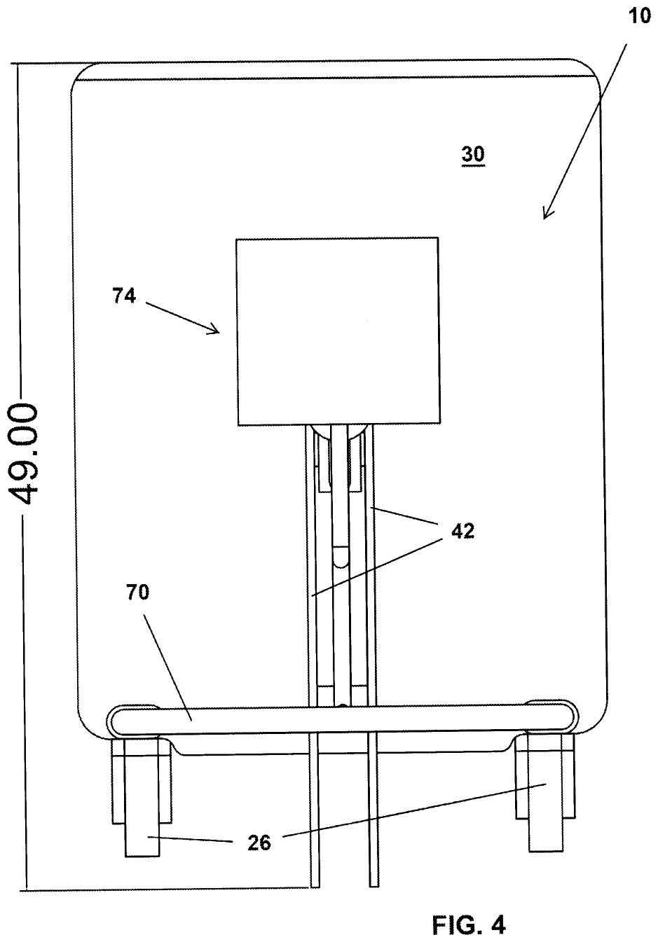

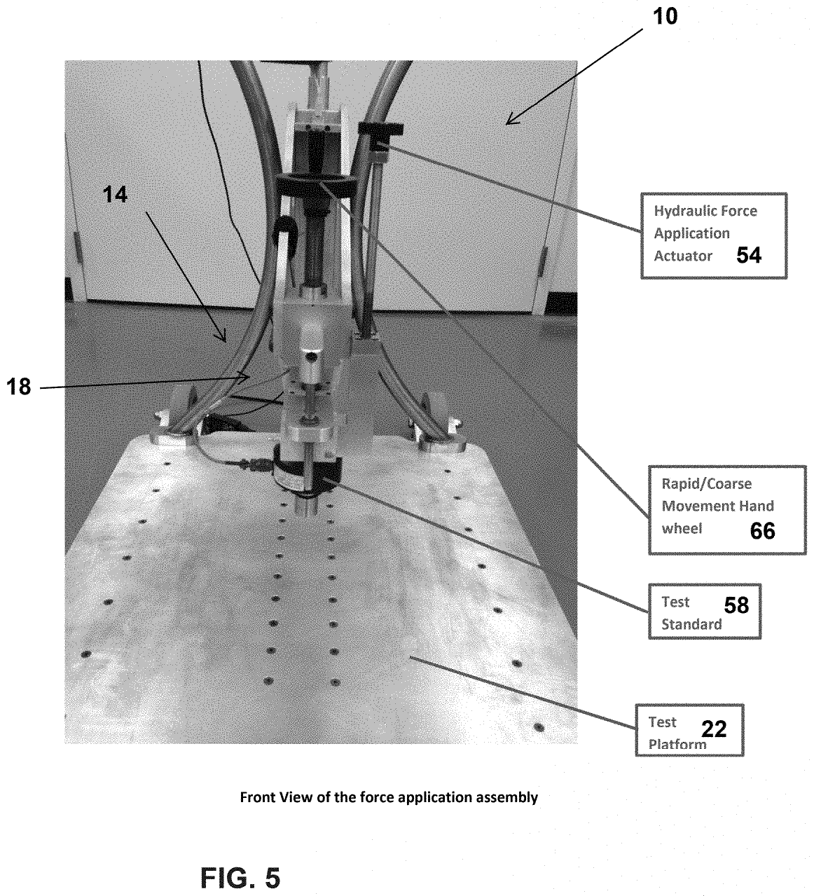

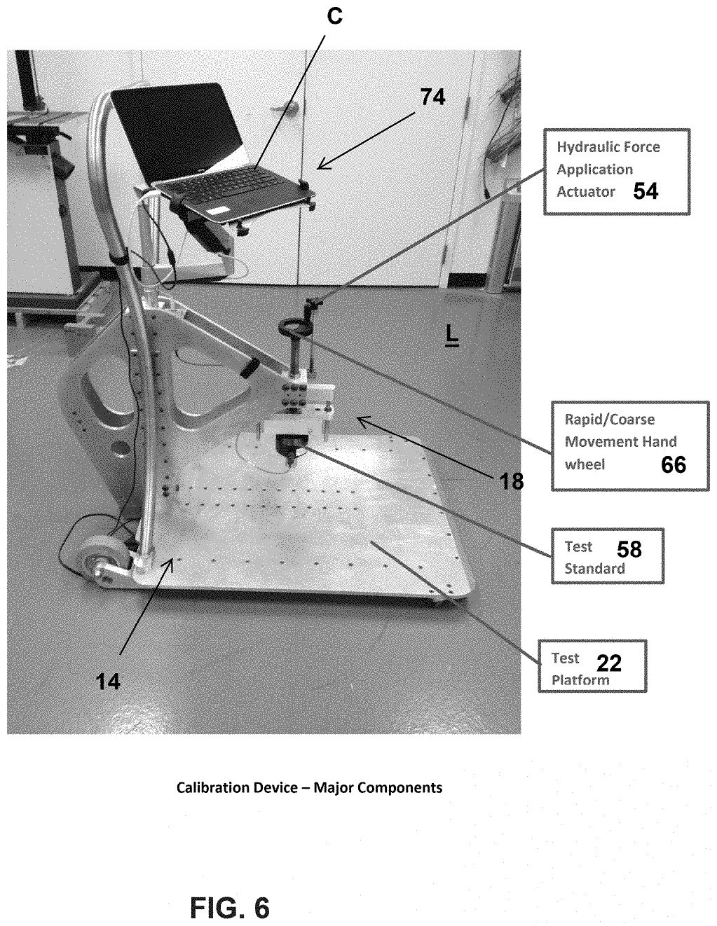

FIGS. 1-7 illustrate a portable, force application device 10 for the calibration, accuracy testing, etc. of a scale S, such as a professional medical scale. FIG. 8 illustrates an alternative construction of the device 10A. In some embodiments, the device 10 may employ test software operating on a computing device C, such as a tablet, laptop, personal computer, desktop, terminal, etc., to monitor an applied force, to log data, and/or to output such data (e.g., provide reports).

Referring to FIGS. 1-4, the device 10 includes a support assembly 14, operable to support the scale S to be calibrated, and a force application assembly 18, operable to apply a force to calibrate the scale S. The support assembly 14 includes a platform or base 22 supportable on and movable along a surface (e.g., on one or more wheels 26) to a location L, such as a doctor's office, other health/medical facility, health club/gym, a user's home, etc., for calibration of a scale S at the location L. The base 22 has an upper surface 30 on which the scale S is supportable.

A frame assembly 34 is attached to the base 22 and, as illustrated, includes a post 38 fixed to a rear edge of the base 22 supporting side plates 42 extending over the base surface 30. The frame assembly 34 supports the force applying assembly 18 over the base surface 30. The base 22 and the frame assembly 34 are constructed to resist reaction forces resulting from support and operation of the force apply assembly 18 and to limit deflection of the force applying assembly 18 (e.g., to about 0.02 inch (in.) or less) during calibration (e.g., under a load up to about 1,200 lbs. or more).

The frame assembly 34 may be fixed to and non-removable from the base 22 or may be removable from the base 22. In constructions in which the frame assembly 34 is removable from the base 22, the device 10 includes a connecting mechanism (not shown; e.g., a positive connecting mechanism (removable pins, fasteners, etc.), a frictional connecting mechanism (a clamp), etc.) to substantially rigidly connect the frame assembly 34 and the base 22 while limiting deflection of the force applying assembly 18.

The device 10 may also include an indicator mechanism (not shown) operable to indicate connection of the frame assembly 34 and the base 22 in an orientation for use. The indicator mechanism may include a visual indicator (e.g., alignable indicator members on the frame assembly 34 and the base 22).

A sensor assembly (not shown) may sense the relative orientation of the frame assembly 34 and the base 22 and communicate sensed information to the computing device C which may provide the indication. In other constructions, the computing device C may use the sensed information to adjust calibration based on the sensed orientation of the components (e.g., the frame assembly 34, the base 22, the force applying assembly 18, etc.).

As illustrated, the base 22 and the frame assembly 34 are arranged generally in a C-shape and are constructed to optimize support of the force applying assembly 18 generally and during use and the size and the weight of the device 10. For example, the illustrated side plates 42 include a web structure with web portions 46 constructed to resist reaction forces resulting from support and operation of the force applying assembly 18 with material removed to decrease weight.

The force applying assembly 18 simulates a dead weight by applying known amounts of force. The force applying assembly 18 may include any suitable force applying mechanism, such as, for example, a load cell, a piston-cylinder assembly, a hydraulic cylinder, a pneumatic cylinder, a screw jack, a screw lift, a motor-driven gear mechanism, an electromagnet, etc.

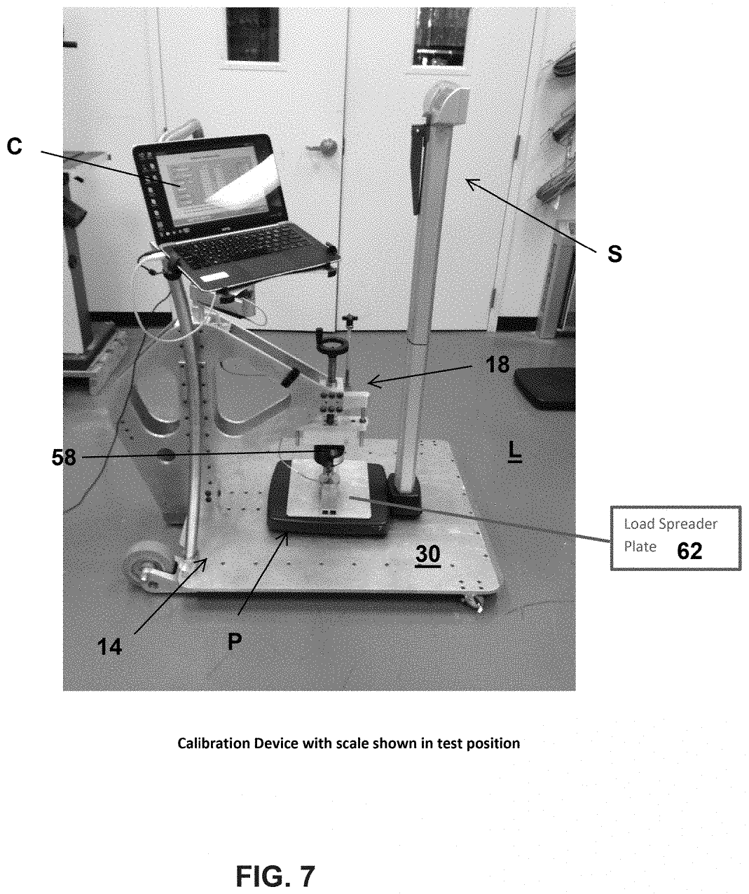

The illustrated force applying assembly 18 includes a hydraulic cylinder assembly 50. An actuator 54 is operable to control the hydraulic cylinder assembly 50 to apply a force. A test standard 58 is supported at the end of the assembly 50 to apply the force to the scale S through a load spreader plate 62 (see FIG. 7) engaging the scale S.

An adjustment mechanism (e.g., a hand wheel 66) is operable to position the test standard 58. The adjustment mechanism may provide rapid or coarse adjustment (e.g., axial sliding along threaded rod) to quickly position the test standard 58 as well as fine adjustment (e.g., threaded adjustment).

The illustrated force applying assembly 18 is rigidly connected to but removable from the frame assembly 34. The rigid connections of the frame assembly 34 may prevent or limit inaccuracy in the applied force. Reaction forces from the force applying assembly 18 may be equally transferred to the base 26 through the frame assembly 34.

A handle 70 is connected to the base 22 and the frame assembly 34 and is engageable by a user for transport and positioning of the device 10. The illustrated handle 70 is removable from the base 22 and the frame assembly 34. A work support assembly 74 extends from the post 38 and is operable to support the computing device C in a position for the user to operate the device 10. The work support assembly 74 includes a support shaft 78 connected to the post 38 and a support member 82 on the support shaft 78. The support member 78 is operable to support the computing device C or other materials (e.g., a medical chart, a notebook, medical instruments, etc.) and is adjustable to be positioned for access by the user. The work support assembly 74, as illustrated, is detachable from the frame assembly 34.

The computing device C may be operable to control the operation of the force applying assembly 18, display or otherwise output data, such as a calibration weight being applied, perform other functions, such as, for example, monitoring the calibration/testing operation, communicating with other devices, logging data, maintaining data, providing reports, controlling the movement of the device 10.

The device 10 may have of any suitable dimensions to be transportable to and around a location (e.g., through a standard doorway) and to support and perform functions on a variety of scales. In certain embodiments, the device 10 has a height of approximately 52.25 in., a width of approximately 31.5 in, and a length of approximately 49.5 in. While being able to provide the minimum calibration weight of at least 300 lbs., the illustrated device 10 has a weight less than or equal to about 300 lbs. or even less than or equal to about 250 lbs.

The device 10 is moved to and positioned in the location for calibration of a scale S. Operation of the device 10 to calibrate or test a scale S may begin with starting the computing device C and the associated device program. The test standard 58 is configured in the appropriate window of the program, and the test series is selected (or configured). When these steps are complete, the device 10 is allowed to “warm-up” for approximately 10 minutes.

The scale S to be tested or calibrated is positioned on surface 30 of the base 22 such that the center of the weighing platform P of the scale S is directly below the test standard 58. The scale S is turned on. The load spreader plate 62 is placed on the scale platform P with the load target directly below the force application point of the test standard 58. The scale S is “zeroed” to account for the weight of the load spreader plate 62. The rapid/coarse movement hand wheel 66 is used to lower the test standard force application point to contact with the load spreader target, resulting in a small amount of force being applied to the scale S.

The actual test force is applied to scale S by turning the actuator 54 (the small hand wheel) to establish the target level of force (as a proxy for a test weight) on the scale S. Data that relates the indicated weight of the test standard 58 to the indicated weight for the scale S is collected. The data is stored, analyzed, output, etc. (e.g., along with collection of at a later time). The device 10 may be operated to calibrate and test the scale S across a load range (e.g., across the entire rated load range of the scale S).

In the illustrated construction, the actuator 54 of the hydraulic cylinder assembly 50 is operated manually to operate the device 10 and calibrate the scale S. In other constructions, the force applying assembly 18 may be controlled by the computing device C to apply forces to the scale S. The program may select a weight/force to be applied, and the force applying assembly 18 may be adjusted to apply the selected force. The operation is continued through calibration of the scale S.

FIG. 8 illustrates an alternative construction of a scale calibration device 10A. The device 10A is similar to the device 10 described above and shown in FIGS. 1-7, and common elements have the same reference number “A”.

In the illustrated device 10A, the base 22A and the frame assembly 34A are arranged generally in a C-shape and are constructed to resist reaction forces resulting from support and operation of the force applying assembly 18A and to limit deflection of the force applying assembly 18A. The illustrated frame assembly 34A includes an angled post 38A connected to the base 22A. A generally vertical first member 86 extends from a rear portion of the post 38A, and a generally horizontal second member 90 connects the upper portion of the first member 86 and the post 38A. The handle (not shown) is removably connectable to the first member 86.

A wheel support 94 extends from opposite lateral sides of the post 38A, and reinforcing members 98 are connected between the outer ends of the wheel support 94 and the first member 86. The rear wheels 26A are positioned on the wheel support 94 at a width no more than the width of a standard truck ramp (e.g., no more than about 24 in.) while still providing a steady and stable support during transport.

To facilitate transportation of the device 10A, at least a portion of the frame assembly 34A may be removable from the base 22A. For example, the post 38A may be disconnectable from the base 22A so that the base 22A and the frame assembly 34A are movable separately and independently. The frame assembly 34A may be subdivided—the post 38A may be disconnectable from the first and second members 86, 90, the reinforcing members 98, etc. The device 10A includes a connection mechanism to substantially rigidly connect the base 22A and the frame assembly 34A and to limit deflection in use.

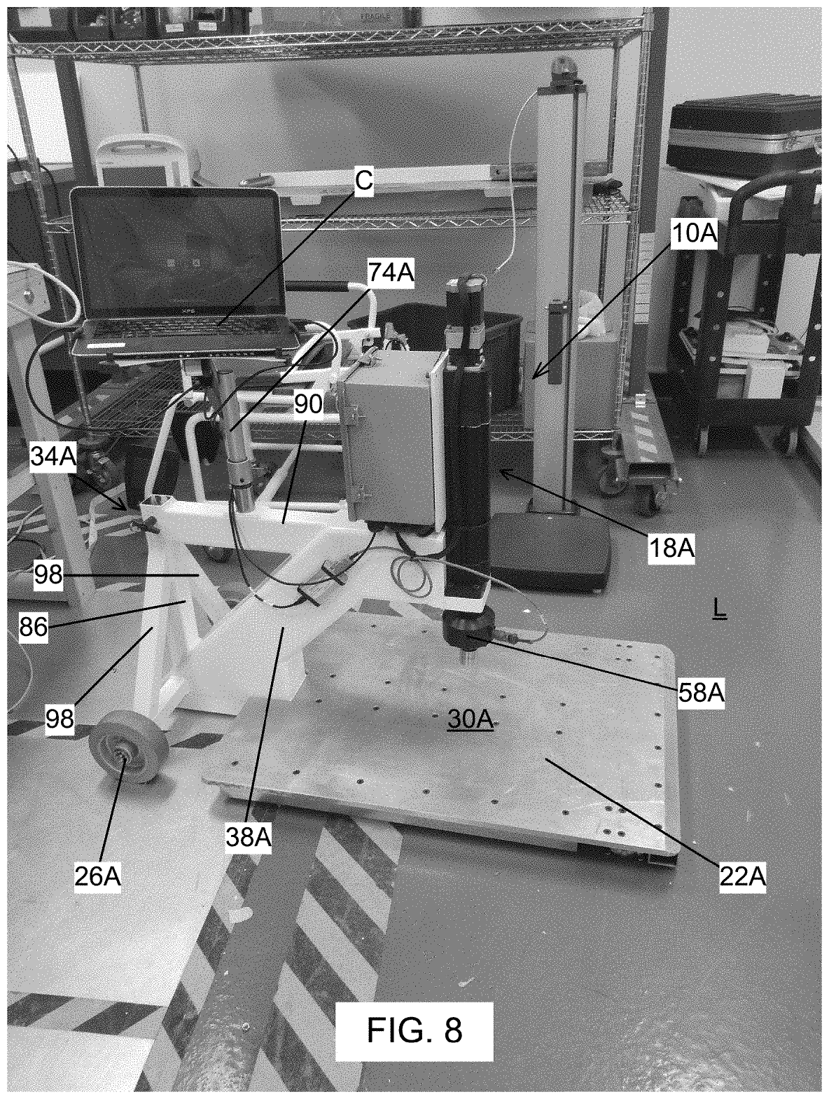

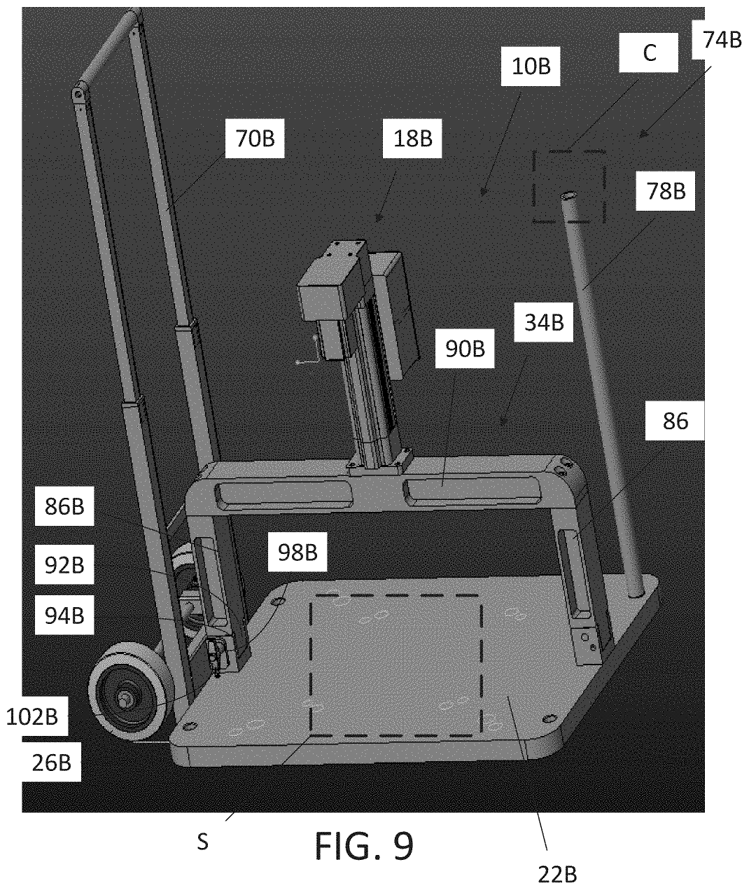

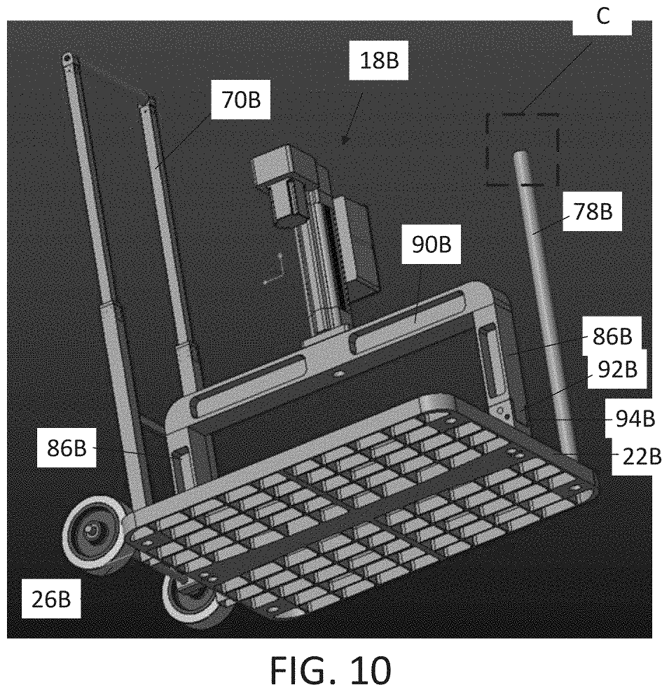

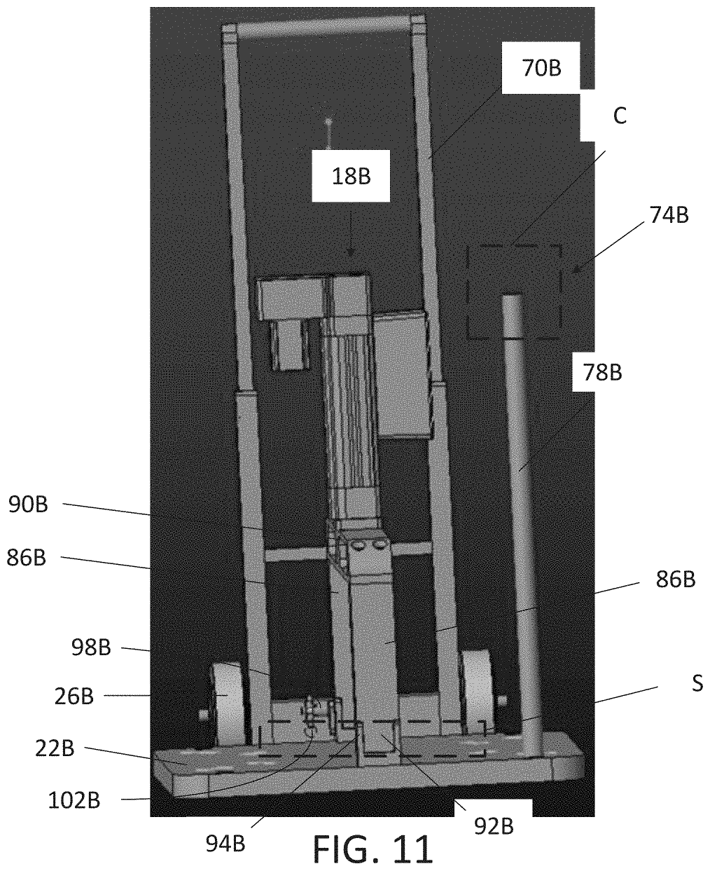

FIGS. 9-11 illustrate another alternative construction of a portable, force application device 10B for calibration, accuracy testing, etc. of a scale S. The device 10B is similar to the device 10, 10A described above and shown in FIGS. 1-8, and common elements have the same reference number “B”.

In the device 10B, the frame assembly 34B is arranged generally as an arch or bridge and is connected to the base 22B to resist reaction forces resulting from support and operation of the force applying assembly 18B. Such an arrangement limits deflection of the force applying assembly 18B, for example, in a direction towards or away from the base 22B, during application of the load.

The illustrated frame assembly 34B includes two generally vertical first members (i.e., columns, beams, uprights 86B, etc.) and a generally horizontal second member (i.e., a span, a bridge, a beam, a crossmember 90B, etc.). The illustrated members 86B, 90B have material removed from one or more walls (e.g., recesses) to, for example, reduce the weight, material, etc. of these components. The uprights 86B are attached at opposing sides of the base 22B. The uprights 86B extend substantially perpendicularly from the base 22B.

The second member 90B extends substantially parallel to the base 22B and spans a gap between the uprights 86B. The illustrated second member 90B is substantially linear but, in other constructions (not shown), could be curved, arched, combination curved and linear, etc. In the illustrated embodiment, the second member 90B is separate from and fastened to the uprights 86B (e.g., by fasteners). In other embodiments (not shown), the second member 90B may be integral with the uprights 86B.

In the illustrated embodiment, the force applicator 18B is positioned on the second member 90B (e.g., substantially at a midpoint between each of the uprights 86B) to promote equal loading on the uprights 86B and vertical loading of the force applicator 18B. As a result, angular deflection of the force applied to the scale S to be calibrated in limited.

At least a portion of the frame assembly 34B may be adjustable relative to and/or removable from the base 22B. For example, the crossmember 90B (with or without the force applicator 18B) may be disconnectable from the uprights 86B and from the base 22B to be movable separately and independently from other components of the device 10B.

In the illustrated construction, the frame assembly 34B is hingedly connected to the base 22B to permit pivoting movement relative to the base 22B, for example, to allow the scale S to be placed on the base 22B, for removal from the base 22B, etc. The illustrated connection mechanism between the upright(s) 86B and the base 22B includes a hinge 92B, a hinge clevis 94B, and a clevis pin 98B. The illustrated hinge 92B is a quick connect hinge pivotably connecting the hinge 92B (e.g., on the upright 86B) with the hinge clevis 94B (e.g., on the base 22B). The clevis pin 98B is engageable in the hinge clevis 94B. The clevis pin 98B is engageable (at 102B) to move the clevis pin 98B into and out of engagement with the hinge clevis 94B to selectively connect and disconnect, respectively, the upright 86B and the base 22B.

In the connection mechanism, the reaction force to the load applied by the force applicator 18B is transferred through the crossmember 90B and the uprights 86B to the base 22B through the hinge 92B to the hinge clevis 94B without transmission through the clevis pin 98B. As such, the major components of the frame assembly 34B (e.g., the members 86B and 90B) are constructed (e.g., made of selected material(s), dimensioned, etc.) to withstand the load.

The illustrated frame assembly 34B can be simplified as a center-loaded simply-supported beam with the crossmember 90B functioning as the beam and the force applicator 18B providing the force. Deflection of the crossmember 90B can be calculated based on the force acting on the center of the beam, the length between the uprights 86B, the modulus of elasticity of the crossmember 90B, the area moment of inertia of the cross section of the crossmember 90B, etc. As such, to minimize deflection of the crossmember 90B, the modulus of elasticity and the area moment of inertia of the crossmember 90B can be maximized. In other words, a high modulus of elasticity material (e.g., steel) with a large area moment of inertia (e.g., an “I” beam) will limit deflection and may improve the accuracy of the device 10B. In the illustrated embodiment, the crossmember 90B is formed of a lightweight aluminum capable of withstanding expected loads while limiting the weight of the device 10B for ease of transport, use, etc.

The device 10B includes rear wheels 26B operable to move the device 10B along a surface for transport of the device 10B. A telescoping handle 70B extends from the base 22B to enable a user to move the device 10B. A work support assembly 74B, including a post 78B, is operable to support a computing device C. The handle 70B and/or the support assembly 74B may be removable.

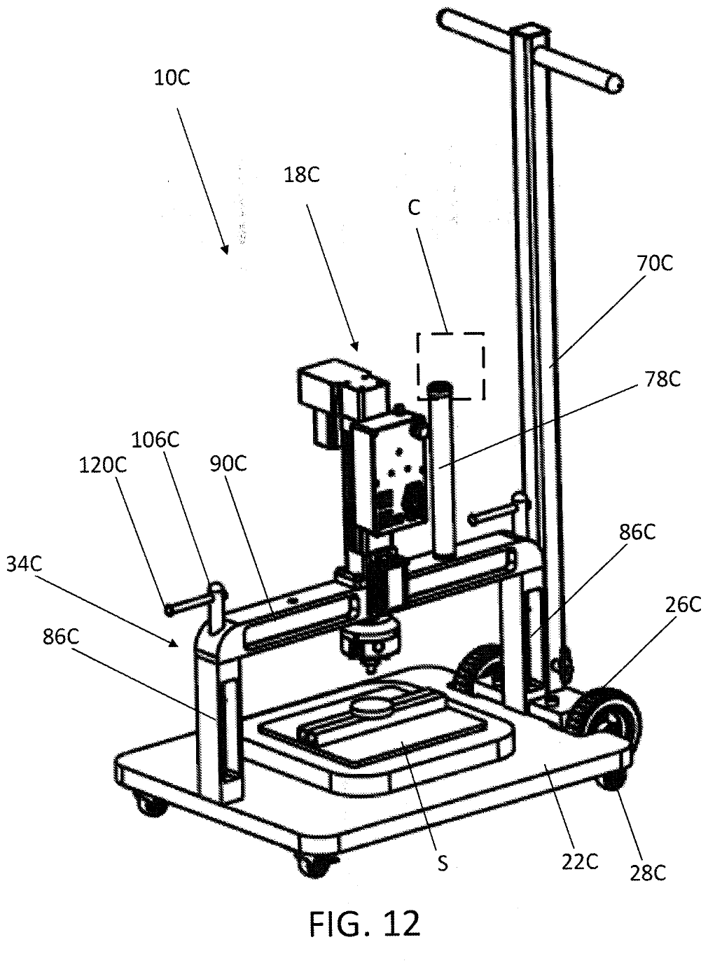

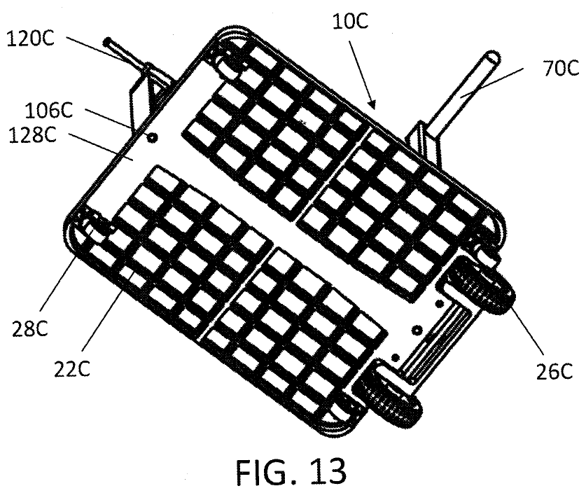

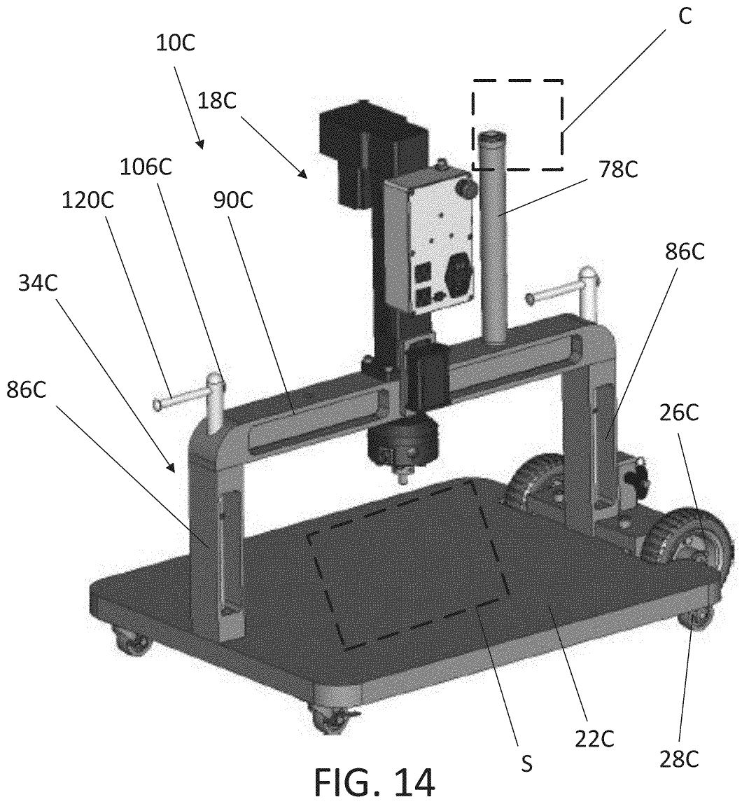

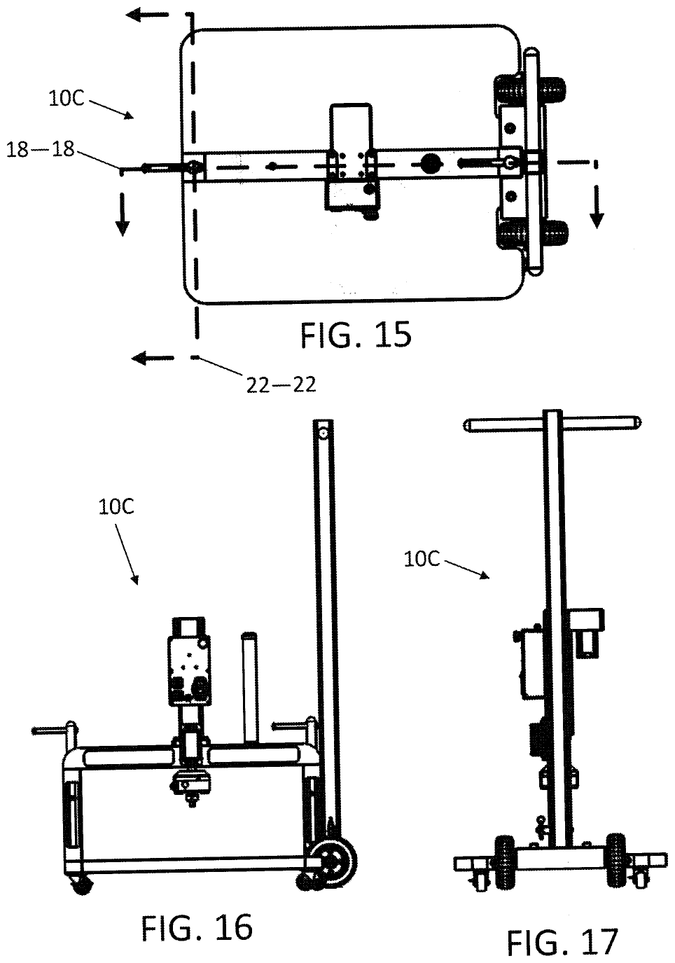

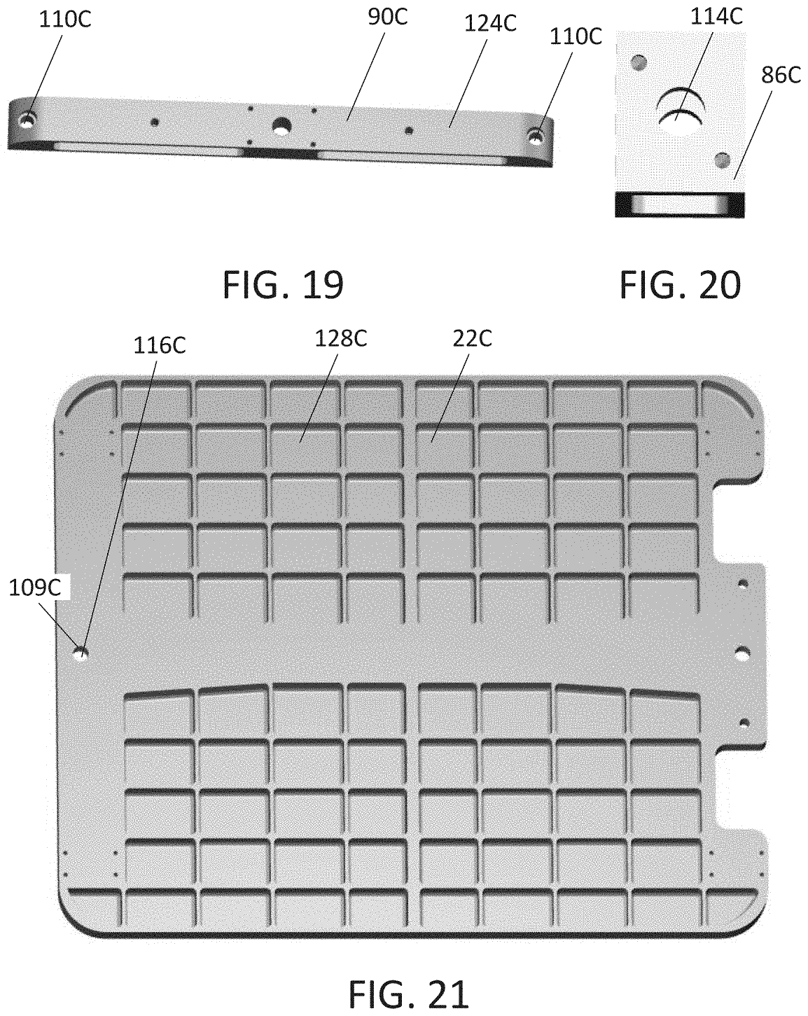

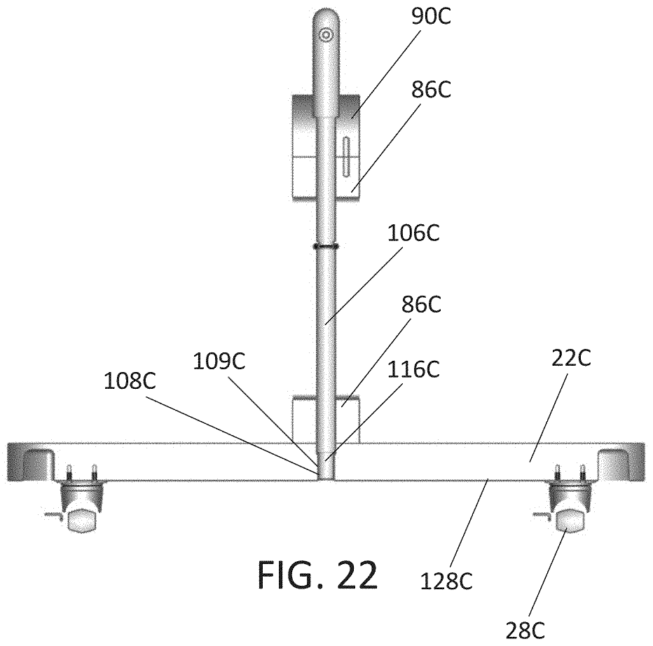

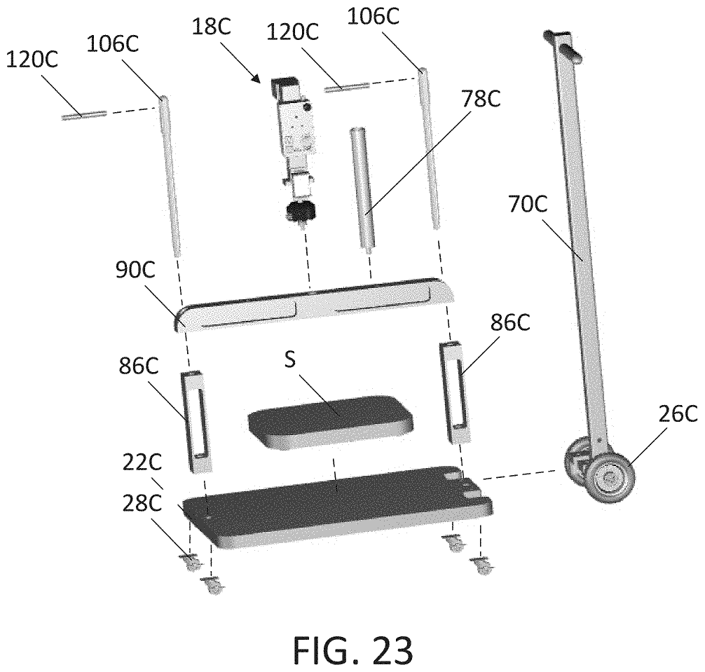

FIGS. 12-23 illustrate yet another alternative construction of a scale calibration device 10C. The device 10C is similar to the device 10, 10A, 10B described above and shown in FIGS. 1-11, and common elements have the same reference number “C”.

As in the device 10B, the frame assembly 34C is arranged generally as an arch or bridge and is connected to the base 22C to resist reaction forces resulting from support and operation of a force applying assembly 18C. The illustrated members 86C, 90C have material removed from one or more walls (e.g., through openings in walls of the uprights 86C, recesses in the cross member 90C) to, for example, reduce the weight, material, etc. of these components.

In the illustrated construction, the frame assembly 34C is removable from the base 22B, with the uprights 86C being disconnectable from the base 22C. A connection mechanism removably connects the frame assembly 34C to the base 22C. The illustrated connection mechanism provides a toolless, quick-connection between the frame assembly 34C and the base 22C. The connection mechanism substantially rigidly connects the frame assembly 34C to the base 22C while limiting deflection of the force applying assembly 18C to, for example, substantially minimize or eliminate inaccuracy that could result from improper or inadequate connection of the frame assembly 34C and the base 22C.

In the illustrated construction, a bolt 106C extends through a receptacle 110C in the crossmember 90C, through a receptacle 114C in the uprights 84C and into a receptacle 116C in the base 22C. The illustrated bolt 106C threadedly engages the base receptacle 116C (e.g., through inter-engaging threaded portions 108C, 109C, respectively). The threaded connection provides a substantially rigid and accurate connection of the frame assembly 34C and the base 22C.

A handle 120C at one end is engageable to rotate and thread the bolt 106C relative to the base 22C to secure (or remove) the frame assembly 34C to the base 22C. The illustrated handle 120C slides through the bolt 106C to be operable on either side of the bolt 120C.

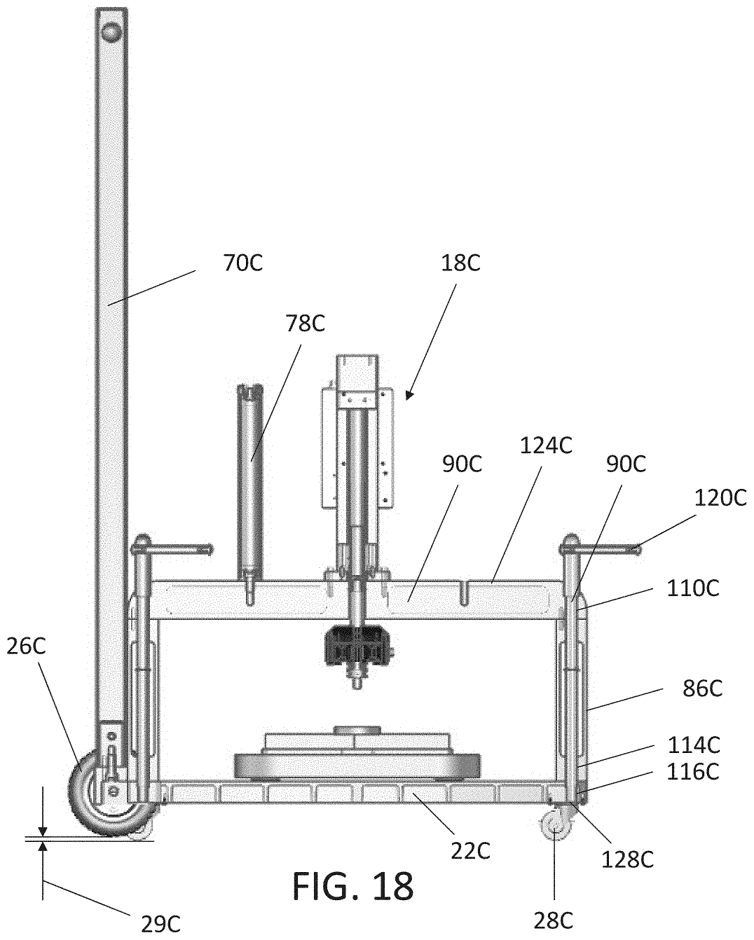

The illustrated bolts 106C are retained in the frame assembly 34C when the frame assembly 34C is removed from the base 22C (e.g., by an O-ring supported on each bolt 106C). Each bolt 106C may be removed from the frame assembly 34C, and, with the bolts 106C removed, the crossmember 90C (with or without the force applicator 18C) may be removed from the uprights 86C. Pins (one shown at each end in FIG. 18) position the members 86C, 90C.

It should be understood that, in other constructions (not shown), the connection mechanism may include different structure to removably connect the frame assembly 34C to the base 22C. For example, the connection mechanism may include a bayonet, a clevis pin, a ¼ turn connection, etc. operable to connect each bolt 106C to the base 22C.

In addition to rear wheels 26C, caster wheels 28C are mounted on the bottom of the base 22C. The caster wheels 28C, the wheels 26C, or a combination can be used to move the device 10C to a desired location L. As illustrated in FIG. 18, with the caster wheels 28C engaging the surface, a clearance 29C is provided between the surface and the wheels 26C. The caster wheels 28C may be locked once the device 10C is in a desired location L. The device 10C may be pivoted from the position shown in FIG. 18 to engage the wheels 26C with the surface and disengage the caster wheels 28C.

A removable T-handle 70C is connected to the base 22C. The support assembly 74C, including the shaft 78C, is removably supported by the frame assembly 34C. As shown in FIG. 18, the crossmember 90C provides locations on opposite sides of the force applicator 18C to support the shaft 78C.

In illustrated embodiments, the device 10, 10A, 10B, 10C may weigh significantly less than (e.g., about 10%) the force that can be applied to calibrate a scale S (for example, a force of up to about 1200 lbs. with a device weight of about 100 lbs.). As such, an operator need only be capable and is only required to transport the 100 lbs. device 10, 10A, 10B, 10C to the location L, place the scale S onto the base 22B, and operate the force applicator 18B to apply up to 1200 pounds of force. Use of the device 10, 10A, 10B, 10C may significantly reduce the physical requirements and effort to operate the device 10, 10A, 10B, 10C when compared to existing devices that require transportation of a test device along with actual, physical test weights.

Further, use of a force applicator 18, 18A, 18B, 18C, as opposed to finite test weights increases the operational range (i.e., the range of the force (simulated weight) that can be applied to the scale S) and deceases or eliminates any gap in test intervals for the device 10, 10A, 10B, 10C. For reference, the illustrated force applicator 18, 18A, 18B, 18C is operable to apply force in a range between about 0.5 lbs. and about 1200 lbs. at about 0.5 lb. intervals. In comparison, existing test devices using finite test weights have a more limited range (up to about 300 lbs. to 500 lbs. of test weights which much be transported along with the test device to the location L), and rely on test weights with values of 5 lbs. to 10 lbs. leaving relatively large gaps between test intervals.

The independent embodiments described above and illustrated in the figures are presented by way of example only and are not intended as a limitation upon the concepts and principles of the present invention. As such, it will be that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

One or more independent features and/or independent advantages may be set forth in the following claims:

What is claimed is:

1. A device comprising:
a base supportable on and movable along a surface to a location, the base including a base surface for supporting a scale to be calibrated proximate the location; and
a frame assembly connected to the base and operable to support, in a position over the base surface, means for simulating a dead weight, the means being operable to apply a force to the scale supported on the base surface.

2. The device of claim 1, further comprising the means for simulating a dead weight supported on the frame assembly.

3. The device of claim 1, wherein the frame assembly includes generally vertical first and second beams connected to the base and a generally horizontal beam extending between the first and second beams.

4. The device of claim 1, wherein the frame assembly is removable from the base.

5. The device of claim 4, further comprising a toolless connection mechanism operable to releasably connect the frame assembly to the base.

6. The device of claim 5, wherein the connection mechanism includes
a rod extending through a portion of the frame assembly and engageable in a recess defined in the base, and
an actuator connected to the rod and operable to move the rod into and out of engagement with the recess to selectively connect and disconnect, respectively, the frame assembly from the base.

7. The device of claim 1, further comprising a work support assembly including a post coupled to one of the frame assembly and the base and a support member connected to the post.

8. The device of claim 1, further comprising one or more wheels connected to the base and operable to move the base along the surface.

9. The device of claim 1, further comprising a handle connected to one of the base and the frame assembly and engageable to position the device relative to the location.

10. A method of calibrating a scale, the method comprising:
moving to a location a calibration device, the calibration device including a base with a base surface and a frame assembly connected to the base;
supporting a scale to be calibrated proximate the location on the base surface; and
with a device supported on the frame assembly over the base surface, applying a force simulating a dead weight to the scale supported on the base surface to calibrate the scale.

11. The method of claim 10, further comprising removing the frame assembly from the base, and wherein moving includes moving the frame assembly and the base separately.

12. A device comprising:
a base supportable on and movable along a surface to a location, the base including a base surface for supporting a scale to be calibrated proximate the location;
a frame assembly connected to the base; and
means for simulating a dead weight supported on the frame assembly in a position over the base surface, the means for simulating a dead weight being operable to apply a force to the scale supported on the base surface to calibrate the scale.

13. The device of claim 12, wherein the frame assembly is removably connected to the base.

14. The device of claim 13, further comprising a connection mechanism operable to connect the frame assembly to the base, the connection mechanism including
a rod extending through a portion of the frame assembly and engageable in a recess defined in the base, and
an actuator connected to the rod and operable to move the rod into and out of engagement with the recess to selectively connect and disconnect, respectively, the frame assembly from the base.

15. The device of claim 12, further comprising a handle removably connected to one of the base and the frame assembly and engageable by a user to position the device relative to the location.

16. The device of claim 12, wherein the frame assembly includes generally vertical first and second beams connected to the base and a generally horizontal beam extending between the first and second beams.

17. The device of claim 16, wherein the means for simulating a dead weight is supported on the horizontal beam proximate a midpoint between the first and second beams.

18. The device of claim 12, wherein the means for simulating a dead weight includes one of a load cell, a piston-cylinder assembly, a hydraulic cylinder, a pneumatic cylinder, a screw jack, a screw lift, a motor-driven gear mechanism, and an electromagnet.

19. The device of claim 18, wherein the means for simulating a dead weight includes a hydraulic cylinder.

20. The device of claim 18, wherein the means for simulating a dead weight includes a motor-driven gear mechanism.
